(19) United States
(12) Patent Application Publication
(10) Pub. No.: US 2025/0262849 A1
(43) Pub. Date: Aug. 21, 2025

(54) FUEL CELL MANUFACTURING DEVICE AND MANUFACTURING METHOD

(71) Applicant: TOYOTA JIDOSHA KABUSHIKI KAISHA, Toyota-shi (JP)

(72) Inventors: Nobuaki NONOYAMA, Chiryu-shi (JP); Takao Kataoka, Nagoya-shi (JP); Kento Nomura Kimu, Nagoya-shi (JP)

(73) Assignee: TOYOTA JIDOSHA KABUSHIKI KAISHA, Toyota-shi (JP)

(21) Appl. No.: 18/966,135

(22) Filed: Dec. 3, 2024

(30) Foreign Application Priority Data
Feb. 21, 2024 (JP) 2024-024953

(51) Int. Cl. B32B 37/12; B32B 37/06; B32B 37/08; B32B 37/10; H01M 8/0297; H01M 8/1004

(52) U.S. Cl. CPC B32B 37/12; B32B 37/06; B32B 37/08; B32B 37/1027; H01M 8/0297; H01M 8/1004; B32B 2457/18

(57) ABSTRACT

A fuel cell manufacturing device includes: a conveying unit for conveying a laminate in which components of the fuel cell are laminated and arranged via an adhesive layer containing a thermoplastic resin material; a heating unit for heating the laminate when the laminate conveyed by the conveying unit is positioned in a predetermined heating zone; a cooling unit for cooling the laminate when the laminate conveyed by the conveying unit is positioned in the predetermined cooling zone after passing through the heating zone; and a pressurizing unit for continuously pressurizing the laminate until the laminate is heated in the heating zone and cooled in the cooling zone.

### CROSS-REFERENCE TO RELATED APPLICATION

This application claims priority to Japanese Patent Application No. 2024-024953 filed on Feb. 21, 2024, incorporated herein by reference in its entirety.

### BACKGROUND

### 1. Technical Field

The present specification relates to a fuel cell manufacturing device and manufacturing method.

### 2. Description of Related Art

A fuel cell is manufactured by integrating a stacked body in which a membrane electrode assembly (MEA) and a gas diffusing layer are sandwiched between a pair of separators by performing heating press and cooling press using an adhesive containing a thermoplastic resin material (Japanese Unexamined Patent Application Publication No. 2020-13734 (JP 2020-13734 A).

### SUMMARY

In the method disclosed in JP 2020-13734 A, the stacked body is set in a predetermined press mold that has been heated, and subjected to heating press under a predetermined condition. After that, the stacked body is demolded, set again in the press mold that has been cooled, and subjected to cooling press. According to the present inventors, it has been found that, according to such a method, positional deviation of cell constituent elements may occur in a fuel cell finally obtained after the heating press. In addition, it has been found that inclusion of air bubbles in the adhesive layer containing the thermoplastic resin material, positional deviation of the adhesive layer, an increase in the non-uniformity of the thickness of the adhesive layer, and thus an increase in the thickness of the entire cell may occur in the fuel cell.

The present specification provides a technique of stably manufacturing a fuel cell having an excellent quality in manufacturing a fuel cell using an adhesive containing a thermoplastic resin material.

The technique disclosed in an aspect of the present specification is embodied as a fuel cell (hereinafter occasionally simply referred to as a “cell”) manufacturing device (hereinafter occasionally simply referred to as a “manufacturing device”).

The manufacturing device includes:
a conveying unit that conveys a stacked body in which constituent elements of a fuel cell are stacked via an adhesive layer containing a thermoplastic resin material;
a heating unit that heats the stacked body when the stacked body conveyed by the conveying unit is positioned in a predetermined heating zone;
a cooling unit that cools the stacked body when the stacked body conveyed by the conveying unit is positioned in a predetermined cooling zone after passing through the heating zone; and
a pressurizing unit that keeps pressurizing the stacked body since the stacked body is heated in the heating zone until the stacked body is cooled in the cooling zone.

According to this manufacturing device, it is possible to keep pressurizing the stacked body since the stacked body is heated in the heating zone until the stacked body is cooled in the cooling zone.

According to the present inventors, it has been found that deformation, movement, and separation, such as warpage of a separator, which is a constituent element of the fuel cell, and expansion of a gas diffusion layer, may occur in the stacked body when a load is released from the stacked body that has been heated and pressurized. In addition, it has been found that, as a result, air bubbles may be caught in the thermoplastic resin material in a molten or softened state, and unintended movement of the thermoplastic resin material may occur. It has been found that the various deterioration in the quality of the fuel cell described above may occur when the stacked body in such a state is cooled and pressurized thereafter.

According to this manufacturing device, the stacked body is kept pressurized even between the heating zone and the cooling zone. Therefore, the above phenomena caused by the release of the load after the heating and pressurizing are suppressed. As a result, positional deviation of cell constituent elements in the finally obtained fuel cell, inclusion of air bubbles in the adhesive layer, positional deviation of the adhesive layer, and an increase in the non-uniformity of the thickness of the adhesive layer are suppressed. Thus, according to this manufacturing device, it is possible to stably manufacture a fuel cell in which constituent elements are bonded with good adhesion by the adhesive layer, the positional deviation of the cell constituent elements and the inclusion of air bubbles in the adhesive layer are suppressed, and the thickness of the adhesive layer is uniform.

The technology disclosed in another aspect of the present specification is embodied as a fuel cell manufacturing method (hereinafter occasionally simply referred to as a “manufacturing method”). The manufacturing method includes: heating and pressurizing a stacked body including an adhesive layer containing a thermoplastic resin material; and cooling and pressurizing the stacked body after the heating and pressurizing. In the manufacturing method, the stacked body after the heating and pressurizing is supplied to the cooling and pressurizing in a state in which at least a predetermined load on the adhesive layer is maintained.

According to this manufacturing method, release of the load on the adhesive layer after the heating and pressurizing and before the cooling and pressurizing is suppressed. If release of the load on the adhesive layer is suppressed, deformation, movement, etc., of the separator and the gas diffusion layer to be bonded by the adhesive layer is also suppressed, and inclusion and movement of air bubbles into the thermoplastic material is also suppressed. Therefore, it is possible to stably manufacture a fuel cell in which constituent elements are bonded with good adhesion by the adhesive layer, the positional deviation of the cell constituent elements and the inclusion of air bubbles in the adhesive layer are suppressed, and the thickness of the adhesive layer is uniform.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing an outline of a fuel cell manufacturing device;

FIG. 2 is a cross-sectional view showing a part of a laminate provided in the manufacturing device shown in FIG. 1;

FIG. 3 is a cross-sectional view showing a part of a state in which a laminate used in the manufacturing device shown in FIG. 1 is sandwiched between jigs;

FIG. 4 is a diagram illustrating a manufacturing process of a fuel cell;

FIG. 5 is a diagram illustrating another embodiment of a manufacturing device; and

FIG. 6 is a view showing another state of the laminate at the time of pressurization.

### DETAILED DESCRIPTION OF EMBODIMENTS

a fuel cell manufacturing device disclosed in the present specification may include the following embodiments in addition to the above-described manufacturing device.

In another embodiment of the manufacturing device, the manufacturing device includes a double belt press apparatus. The double belt press apparatus includes a pair of upper and lower belts constituting the conveying unit, a heating press part constituting a part of the heating unit and the pressurizing unit, and a cooling press part constituting another part of the cooling unit and the pressurizing unit. According to this manufacturing device, it is efficiently performed to continue pressurizing the laminate during a period from when the laminate is heated in the heating zone to when the laminate is cooled in the cooling zone.

Another embodiment of the manufacturing device comprises a continuous roller press. The continuous roller press device includes a pair of upper and lower roller conveyors constituting the conveying unit. The pair of upper and lower roller conveyors includes a heating press portion forming a part of the heating unit and the pressurizing unit, and a cooling press portion forming another part of the cooling unit and the pressurizing unit. According to this manufacturing device, it is efficiently performed to continue pressurizing the laminate during a period from when the laminate is heated in the heating zone to when the laminate is cooled in the cooling zone.

In another embodiment of the manufacturing device, the pressurizing unit includes a jig that sandwiches the laminate in a lamination direction of the laminate and is capable of pressing the adhesive layer. The jig includes a pair of plates sandwiching the laminate, a positioning member for suppressing positional deviation in a direction orthogonal to the stacking direction of the laminate of the pair of plates. By having such a jig, it is possible to easily pressurize the laminate. It is also easier to maintain the load on the laminate. Further, according to such a jig, the positional deviation of the pair of plates is suppressed, and the positional deviation of the cell components in the stacked body is suppressed.

In addition to the above-described manufacturing method, the manufacturing method of the fuel cell disclosed in the present specification can include an embodiment implemented using the manufacturing device of the various embodiments described above.

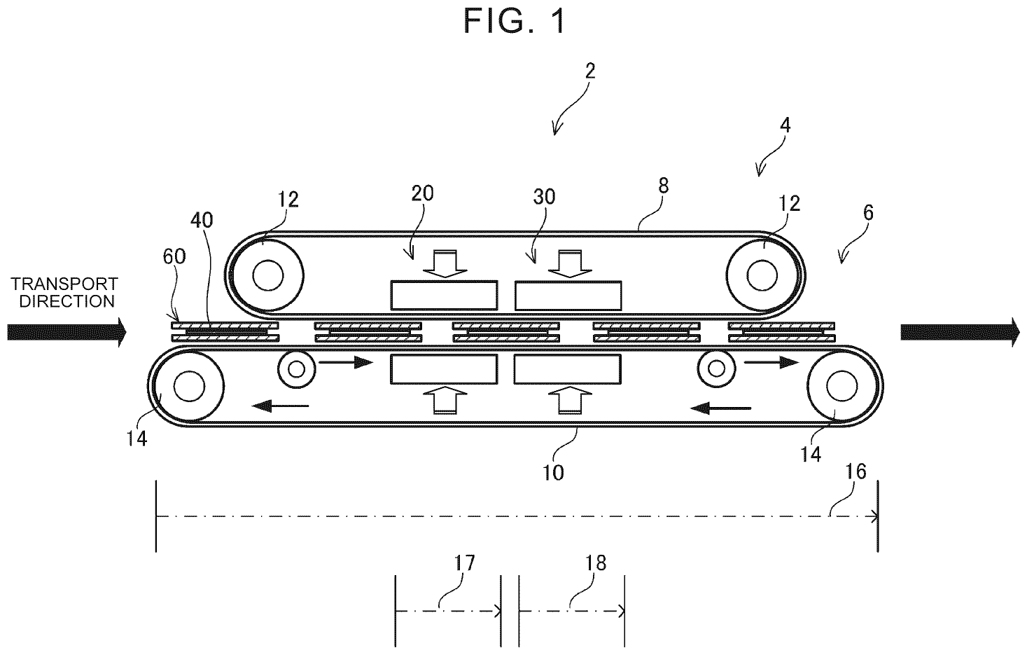

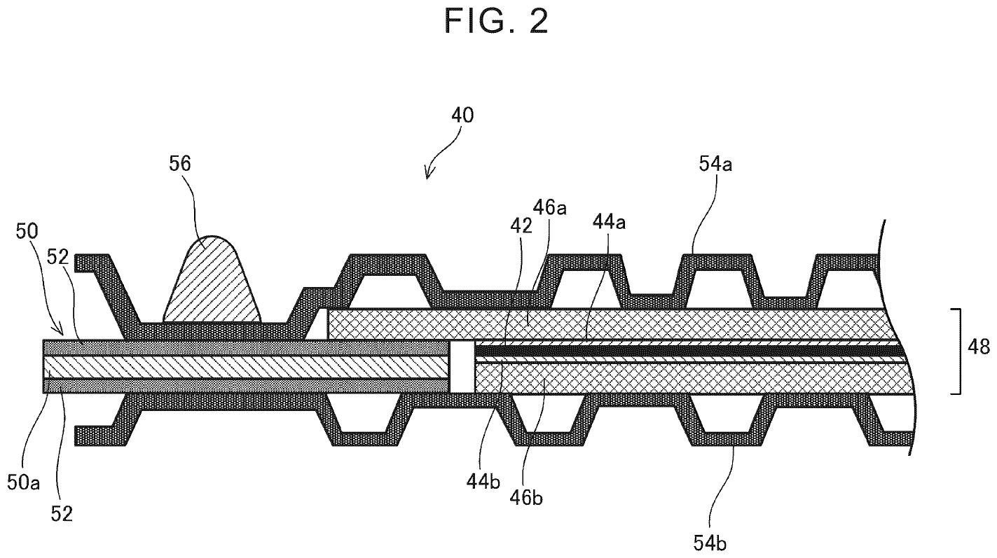

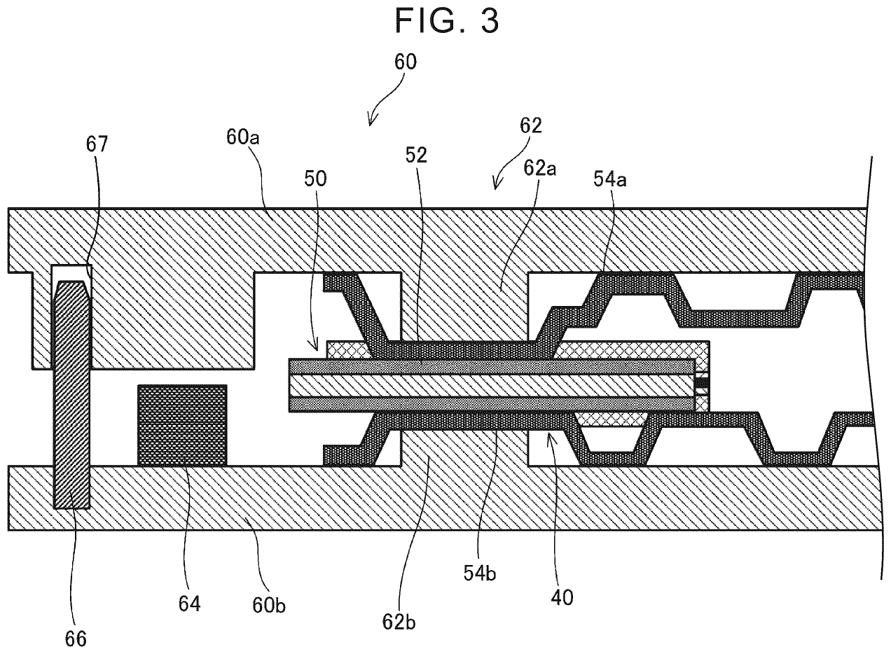

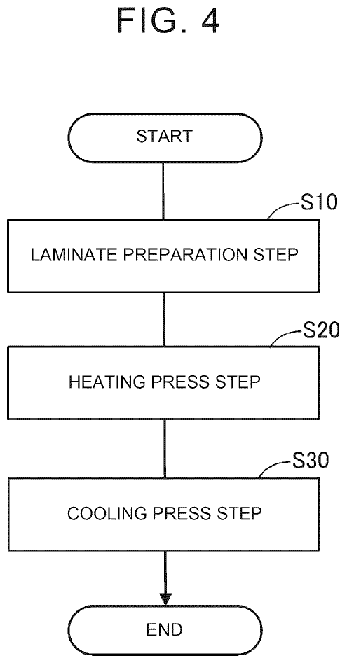

Hereinafter, a manufacturing device and a manufacturing method disclosed in the present specification will be described in detail with reference to the drawings as appropriate. FIG. 1 shows an outline of a manufacturing device, FIG. 2 shows a laminate to be used in a manufacturing device, FIG. 3 shows a state in which the laminate to be used in the manufacturing device is sandwiched by a jig, and FIG. 4 shows a manufacturing process of a fuel cell.

The manufacturing device 2 is not particularly limited, but can be used, for example, for manufacturing a fuel cell as a driving power source or a mounting power source of a moving body such as a vehicle. The type of the fuel cell is not particularly limited, but may be a polymer electrolyte fuel cell (PEFC) from the viewpoint of operating temperature and the like.

As shown in FIG. 1, the manufacturing device 2 is a double belt press type manufacturing device. The manufacturing device 2 includes a double belt portion 4 as a conveying unit, a heating press unit 20 for pressurizing and heating the laminated body 40, and a cooling press unit 30 for pressurizing and cooling the laminated body 40 in the same manner. The laminated body 40 will be described later.

As the double belt portion 4, various known double belt pressing apparatuses can be used. The double belt portion 4 includes a pair of upper and lower belts 6 including an upper belt 8 and a lower belt 10. The upper belt 8 is disposed between the pair of upper drums 12. The lower belt 10 is disposed between a pair of lower drums 14. Each of the upper belt 8 and the lower belt 10 is a metal belt such as stainless steel.

The pair of belts 6 define a transport zone 16 of the laminated body 40 in its length direction. A heating zone 17 and a cooling zone 18 of the laminated body 40 are included in an area of the pair of belts 6 where the upper belt 8 and the lower belt 10 face each other. A cooling zone 18 is provided downstream of the heating zone 17 in the conveying direction.

Each of the heating press unit 20 and the cooling press unit 30 is a part of a double belt press apparatus. The heating press unit 20 is arranged in the heating zone 17 of the manufacturing device 2. It can be said that the heating press unit 20 defines the heating zone 17. The heating press unit 20 includes a heating press device capable of pressurizing and heating the laminated body 40 sandwiched between the pair of belts 6 at a predetermined pressure and temperature. The heating press unit 20 can be appropriately configured by a person skilled in the art based on a known double belt press apparatus. The heating press unit 20 is an example of a part of the heating unit and the pressurizing unit disclosed herein.

The cooling press unit 30 is arranged in the cooling zone 18 of the manufacturing device 2. It can be said that the cooling press unit 30 defines the cooling zone 18. The cooling press unit 30 includes a cooling press device capable of pressurizing and cooling the laminated body 40 sandwiched between the pair of belts 6 in the cooling zone 18 at a predetermined pressure and temperature. Such a cooling press unit 30 can be appropriately configured by a person skilled in the art based on a known double belt press apparatus. Note that the cooling in the present specification includes not only positive cooling but also natural cooling and air blowing. The cooling press unit 30 is an example of another part of the cooling unit and the pressurizing unit disclosed herein.

In the embodiment shown in FIG. 1, the heating press unit 20 and the cooling press unit 30 are disposed close to each other in the transport zone 16. For example, the cooling press unit 30 is disposed on the downstream side of the heating press unit 20 at a distance of, for example, half or less, 40% or less, 30% or less, 20% or less, or 10% or less of the length along the conveying direction of the laminated body 40. In this way, the laminated body 40 is subjected to a cooling press in the cooling zone 18 after being heated and pressed in the heating zone 17, while substantially leaving the load by the heating press unit 20.

Downstream of the cooling zone 18, the laminated body 40 is conveyed further downstream by the lower belt 10.

Here, the laminated body 40 will be described. The laminated body 40 is a stacked body before joining a fuel cell (hereinafter, simply referred to as a cell) to be manufactured by the manufacturing device 2. As illustrated in FIG. 2, the laminated body 40 includes an electrolyte membrane 42, an anode catalyst layer 44a, a cathode catalyst layer 44b, gas diffusion layers 46a, 46b, a resin sheet 50, and a pair of separator 54a, 54b.

The electrolyte membrane 42 is a solid polymer electrolyte membrane. The anode catalyst layer 44a and the cathode catalyst layer 44b are stacked with both surfaces of the electrolyte membrane 42 interposed therebetween. The gas diffusion layer 46a, 46b is a porous material capable of diffusing hydrogen in the anode catalyst layer 44a and oxygen in the cathode catalyst layer 44b. These components together constitute a MEGA 48. MEGA 48 is integrated with the resin-sheet 50. MEGA 48 is sealed to the opening of the resin-sheet 50 by a suitable sealing material (not shown) so that the gas diffusion layers 46a, 46b do not communicate with each other, and is held at the same time.

The resin-sheet 50 has a frame shape having an opening portion capable of holding a MEGA 48 at a central portion thereof. As shown in FIG. 2, the resin sheet 50 has, for example, a three-layer structure. The resin sheet 50 includes an adhesive layer 52 including a thermoplastic resin material on both surfaces of the core layer 50a. The core-layer 50a is made of a resin having a melting point higher than that of the thermoplastic resin material contained in the adhesive layer 52, and is made of a resin that does not soften at the time of heating of the laminated body 40.

The thermoplastic resin material contained in the adhesive layer 52 is a so-called hot melt adhesive. The adhesive layer 52 is similarly formed in a frame shape on both surfaces of the core-layer 50a formed in a frame shape. The adhesive layers 52 are formed in regions where the resin-sheet 50 and the separator 54a, 54b need to be bonded to each other. The adhesive layers 52 are brought into close contact with and bonded to the separator 54a, 54b by being heated and cooled, and integrate MEGA 46 and the separator 54a, 54b.

The hot melt adhesive is solid at room temperature, melts or softens by heating, and solidifies again by cooling to form a joint. Examples of the hot-melt adhesive include adhesives based on various thermoplastic resins such as polyester-based and modified olefin-based adhesives. The hot-melt adhesive used for the adhesive layer 52 can be appropriately selected from various known hot-melt adhesives in consideration of the melting point and the like.

The separator 54a, 54b sandwiches MEGA 48 and supplies a predetermined gas to the gas diffusion layers 46a, 46b. The separator 54a, 54b is made of, for example, a metallic material such as aluminum or stainless-steel, a carbon-based composite material, or the like. The separator 54a, 54b has a corrugated configuration in which the gas can be supplied to the gas diffusion layers 46a, 46b facing each other.

As shown in FIG. 2, the laminated body 40 may further include a gasket 56 on a side surface of the separator 54a that does not face the resin-sheet 50. The gasket 56 seals between the cells in the stack of fuel cells. The gasket 56 is formed of an elastic body such as a resin or an elastomer. Gasket 56 is an example of an elastomer used to pressurize the adhesive layer disclosed herein.

The laminated body 40 shown in FIGS. 2 and 3 has a planar shape having a rectangular shape as a whole. In the laminated body 40, a gas flow path is formed by a separator 54a, 54b so as to be able to flow in such a manner that hydrogen and oxygen are opposed to each other along the long side.

As shown in FIG. 3, the laminated body 40 is supplied to the manufacturing device 2 in a state of being restrained by a jig 60 that sandwiches the laminated body 40. The jig 60 includes an upper plate 60a and a lower plate 60b. The upper plate 60a is brought into contact with the upper belt 8 and can apply a load to the laminated body 40 from 54a of the separators. The lower plate 60b is brought into contact with the lower belt 10 and can apply a load to the laminated body 40 from 54b of the separators. The upper plate 60a and the lower plate 60b each have a larger planar configuration than the outer edge of the laminated body 40.

The upper plate 60a and the lower plate 60b are provided with pressing portion 62 required for joining the separator 54a, 54b of the laminated body 40 and the adhesive layers 52 of the resin sheet 50. The pressing portion 62 is a convex portion protruding toward the laminated body 40. Although the mode of the pressing portion 62 is not particularly limited, for example, as shown in FIG. 3, the pressing portions 62a, 62b may be provided so as to face each other.

The pressing portion 62 may be formed of, for example, a metallic material or the like made of the same material as the upper plate 60a and the lower plate 60b, or may be formed of an elastic material made of, for example, a resinous material, an elastomeric material, or the like. Note that, at the place where the gasket 56 is disposed, the adhesive layers 52 may be pressed by being sandwiched between the upper plate 60a and the lower plate 60b without forming the pressing portion 62. Further, a pressing portion 62 that presses the gasket 56 may be separately provided as necessary.

Further, the jig 60 includes a restraining member 64 that is restrainable with respect to each other. The restraining member 64 is configured to restrain the upper plate 60a and the lower plate 60b from the hot pressing process to the cold pressing process of the laminated body 40. The restraining member 64 is provided at one or a plurality of positions on the outer periphery of the laminated body 40 of the jig 60. As the restraining member 64, for example, as shown in FIG. 3, when the upper plate 60a and the lower plate 60b are made of a metallic material having magnetism such as stainless-steel, a restraining material made of a magnetic force such as magnets can be used. The restraining member 64, which is a magnet, is fixed to the lower plate 60b so as to be attracted and fixed to the upper plate 60a, for example. Thus, once the upper plate 60a and the lower plate 60b are constrained to each other, the opening of the load to the laminated body 40 is suppressed between them.

Further, the jig 60 includes a positioning member 66 for positioning the upper plate 60a and the lower plate 60b. The positioning member 66 fixes mutual positions of the upper plate 60a and the lower plate 60b in a direction perpendicular to the stacking direction of the laminated body 40 (hereinafter, referred to as a lateral direction) in a predetermined position. As a result, lateral displacement of the upper plate 60a and the lower plate 60b is suppressed through the hot pressing process and the cold pressing process, and a predetermined load is applied to a predetermined area of the laminated body 40. In addition, lateral displacement of the separator 54a, 54b, the gas diffusion layer 46a, 46b, and the like, which are cell components of the laminated body 40, is also suppressed.

Although the embodiment of the positioning member 66 is not particularly limited, for example, as shown in FIG. 3, a positioning pin fixed to the lower plate 60b may be used. The positioning member 66 extends toward the upper plate 60a in the thickness direction of the laminated body 40, and is fitted into a positioning hole 67 formed in the upper plate 60a.

Next, with reference to FIG. 4, a process of manufacturing a cell from the laminated body 40 will be described. The laminate preparation step S10 is a step of preparing the laminated body 40 in which the separator 54a, 54b is laminated on the resin-sheet 50 holding MEGA 48. Note that the laminate preparation step S10 may be one in which the laminated body 40 is prepared by manufacturing the laminated body 40, or one in which the laminated body 40 manufactured in advance is prepared.

In the present embodiment, the upper plate 60a and the lower plate 60b are configured such that a load to the laminated body 40 is easily held by the restraining member 64. Further, the positional displacement of the plate 60a, 60b is suppressed by the positioning member 66.

The prepared laminated body 40 is nipped by the jig 60 and supplied to the transport zone 16 of the manufacturing device 2. The laminated body 40 is fed onto the lower belt 10 of the manufacturing device 2 and reaches the heating zone 17.

The heating press step S20 is a step of heating and pressurizing the laminated body 40 that has reached the heating zone 17. The laminated body 40 is heated between the pair of belts 6 by the heating press unit 20 at a predetermined pressure and a predetermined temperature. The heating time in the heating press step S20 is defined by the time required for the laminated body 40 to stagnate in the heating press unit 20 and/or pass through the hot pressurizing unit 20 by the pair of belts 6. The temperature, the pressure, and the heating time in the heating press step S20 are appropriately determined in accordance with the properties of the hot-melt adhesive used for the adhesive layers 52.

The laminated body 40 that has passed through the heating press unit 20 is immediately reached to the cooling zone 18 in a state of being sandwiched between the pair of belts 6 together with the jig 60.

The cooling press step S30 is a process of cooling and pressurizing the laminated body 40 that has reached the cooling zone 18. The laminated body 40 is cooled at a predetermined pressure and a predetermined temperature by the cooling press unit 30 between the pair of belts 6. The cooling time in the cooling press step S30 is defined by the time required for the stack to stagnate in the cooling press unit 30 and/or pass through the cooling press unit 30 by the pair of belts 6. Temperature, pressure, and cooling time in the cooling press step S30 are appropriately determined in accordance with the properties of the hot melt adhesive used for the adhesive layers 52, and the like.

In the present embodiment, in other words, the heating press unit 20 and the cooling press unit 30 are separated from each other by a distance shorter than the length along the conveying direction of the laminated body 40 in the heating zone 17 and the cooling zone 18. Therefore, the cooling press unit 30 pressurizes the laminated body 40 in a state in which the pressurizing state by the heating press unit 20 is maintained.

The laminated body 40 that has passed through the cooling press unit 30 is conveyed between the pair of belts 6, is further conveyed in a predetermined section by the lower belt 10, and is then taken out from the manufacturing device 2. Further, the cells are taken out from the jig 60.

According to the embodiment described above, the laminated body 40 is cooled and pressurized without removing the pressurization in the heating press step S20. Since the load is not completely released prior to the cooling press step S30 after the heating press step S20, the generation of phenomena that may be caused by the release of the load is suppressed. That is, the separators 54a, 54b, which are the constituent elements of the laminated body 40, are suppressed from warping or the gas diffusion layers 46a, 46b are suppressed from expanding. Therefore, the separators 54a and the gas diffusion layer 46a are suppressed from being separated from each other or from being displaced from each other prior to the cooling press step S30.

Further, even when the hot-melt adhesive of the adhesive layers 52 is melted or softened by heating, the entrapment of bubbles is suppressed prior to the cooling press step S30. In addition, prior to the cooling press step S30, uneven thickness of the adhesive layers 52 due to unintentional movement of the hot melt adhesive is suppressed.

As described above, the laminated body 40 in which the load in the heating press step S20 is not completely released and a predetermined load is maintained is supplied to the cooling press step S30, and is cooled and pressurized. Therefore, the adhesive layer 52 is bonded to the cell components such as the separator 54a and the gas diffusion layer 46a with good adhesion, and the misalignment of the cell components is suppressed. As a result, the inclusion of bubbles in the adhesive layer 52 is suppressed, and a cell in which the thickness of the adhesive layer 52 is uniform is obtained. As a result, the total thickness of the cell is suppressed from being unintentionally increased.

Further, according to the above-described embodiment, the laminated body 40 is sandwiched by the jig 60, and the heating press step S20 and the cooling press step S30 are performed. When pressurized in the heating press step S20, a constant load is maintained on the laminated body 40 by the restraining member 64. Therefore, the separation and positional deviation of the cell components, the inclusion of bubbles in the adhesive layer 52, and the non-uniformity of the thickness of the adhesive layer 52 are further suppressed through the manufacturing process. Further, the jig 60 may be useful when the heating zone 17 and the cooling zone 18 are spaced apart from each other by more than the length of the laminated body 40 in the conveying direction. By using the jig 60, the adhesive layers 52 of the laminated body 40 may be applied with a constant load only by the jig 60 up to the cooling press step S30 after the heating press step S20.

Further, according to the above-described embodiment, the position of the upper plate 60a and the lower plate 60b of the jig 60 is fixed and held by the positioning member 66 in the laminated body 40. Therefore, a lateral positional deviation between the upper plate 60a and the lower plate 60b due to a velocity difference between the pair of belts 6 and the like, and consequently, a lateral positional deviation of the cell components of the laminated body 40 are suppressed. As a result, misalignment of the cell components, inclusion of bubbles in the adhesive layer 52, non-uniformity of the thickness of the adhesive layer 52, and the like are further suppressed.

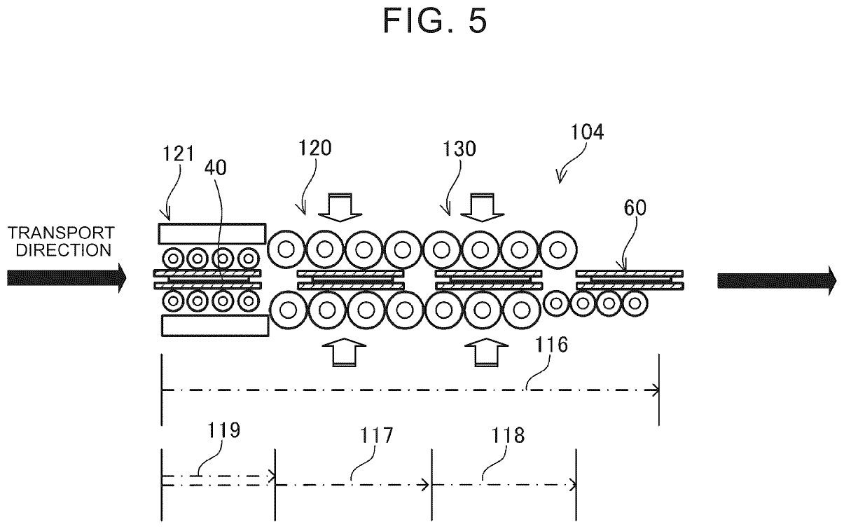

In the above embodiment, a double belt press apparatus is used as the manufacturing device 2, but the present disclosure is not limited thereto. Various known conveying unit, heating unit, cooling unit and pressurizing unit can be combined as appropriate. As another manufacturing device 102, for example, a continuous roller press apparatus can be used. As illustrated in FIG. 5, the manufacturing device 102 includes a roller conveyor 104 including a pair of upper and lower rollers arranged in series as a conveying unit. The roller conveyor 104 defines a transport zone 116 and may further define a heating zone 117 and a cooling zone 118.

The heating zone 117 includes an appropriate number of roller pairs, and includes a heating press unit 120 that heats and presses the laminated body 40. The cooling zone 118 is composed of an appropriate number of roller pairs, and includes a cooling press portion 130 for cooling and pressurizing the laminated body 40. The heating press unit 120 is an example of a portion of the heating unit and the pressurizing unit disclosed herein. The cooling press portion 130 is an example of a portion of the cooling unit and the pressurizing unit disclosed herein.

As shown in FIG. 5, the pair of rollers is arranged continuously in each of the heating press unit 120 and the cooling press portion 130. The most downstream roll pair of the heating press unit 120 and the most upstream roll pair of the cooling press portion 130 are also arranged in succession. As a result, the laminated body 40 sandwiched by the jig 60 continues to be pressurized by the pair of rolls from the heating press unit 120 to the cooling press portion 130.

Further, in the manufacturing device 102 shown in FIG. 5, a preheating unit 121 such as a halogen heater that heats the laminated body 40 from above and below in the lamination direction in advance is provided in front of the heating zone 117. By providing the preheating unit 121, the hot melt adhesive can be reliably melted or softened by the heating press unit 120. In this case, it is preferable that the laminated body 40 is sandwiched by the jig 60 so that movement of the cell component or the like is suppressed. As shown in FIG. 5, the preheating unit 121 may also be a preheating zone 119 in preparation for a part of the roller conveyor 104. The preheating unit 121 and the preheating zone 119 may be part of the heating press unit 120 and the heating zone 117. Further, in the roll pair constituting the cooling press portion 130, the laminated body 40 may be pressurized while being cooled by cooling, blowing, or the like.

In the manufacturing device 102 illustrated in FIG. 5, the laminated body 40 is preferably provided in a state of being sandwiched by a jig 60 or the like.

In the above-described embodiment, the heating press units 20 and 120 and the cooling press units 30 and 130 are separated from each other by a distance shorter than the length of the laminated body 40 in the conveyance direction. Therefore, the laminated body 40 is supplied to the cooling press step S30 while the load applied by pressurization is substantially maintained in the heating press step S20 until the cooling press step S30 after the heating press step S20. That is, the laminated body 40 continues to be pressurized from the time when the laminated body 40 is heated to the time when it is cooled.

However, the form of maintaining the load on the laminated body 40 is not limited thereto. It is sufficient that a load is applied to the adhesive layers 52 of the laminated body 40 to such an extent that separation or positional deviation of the cell components can be suppressed before the cooling press step S30 after the heating press step S20 Such a load can be appropriately set by a person skilled in the art. It is also possible to provide an independent pressing step of maintaining at least a part of the load after the heating press step S20 prior to the cooling press step S30 without completely opening the load prior to the heating press step S20. In some cases, such a load can be achieved by the restraining member 64 with respect to the jig 60 without using a pressurizing unit such as a pressing device.

In the above-described embodiment, the jig 60 is used to maintain at least a part of the load applied to the adhesive layers 52 by the heating press step S20 by continuously pressurizing the entire laminated body 40, but the present disclosure is not limited thereto. At least a portion of the load may be maintained only in the adhesive layer 52.

In the above-described embodiment, the manufacturing devices 2 and 102 perform the heating press step S20 and the single cooling press step S30, but the present disclosure is not limited thereto. The heating press step S20 and the cooling press step S30 may each comprise a plurality of sub-steps. It is preferable that a predetermined load is maintained between the plurality of sub-heating steps to the extent that deformation and movement of the cell component can be suppressed. It is preferable that the load is maintained between the plurality of sub-cooling steps as well.

In the above embodiment, in the heating press step S20, the laminated body 40 is pressurized and heated at the same time, but the present disclosure is not limited thereto. For example, as shown in FIG. 5, the preheating unit 121 may be used to preheat the laminated body 40 to melt or soften the adhesive layer 52. Further, the heating at the time of the heating press may be replaced by such preheating, and only the pressurization may be performed after the heating. For example, in FIG. 5, a state in which the hot melt adhesive exhibits adhesiveness by preheating may be maintained, and in a pair of downstream rollers constituting the heating press unit 120, the special laminated body 40 may be pressurized without heating. Further, the cooling press step S30 may be, for example, a step of pressurizing the laminated body 40 while cooling by natural cooling without particularly aggressive cooling.

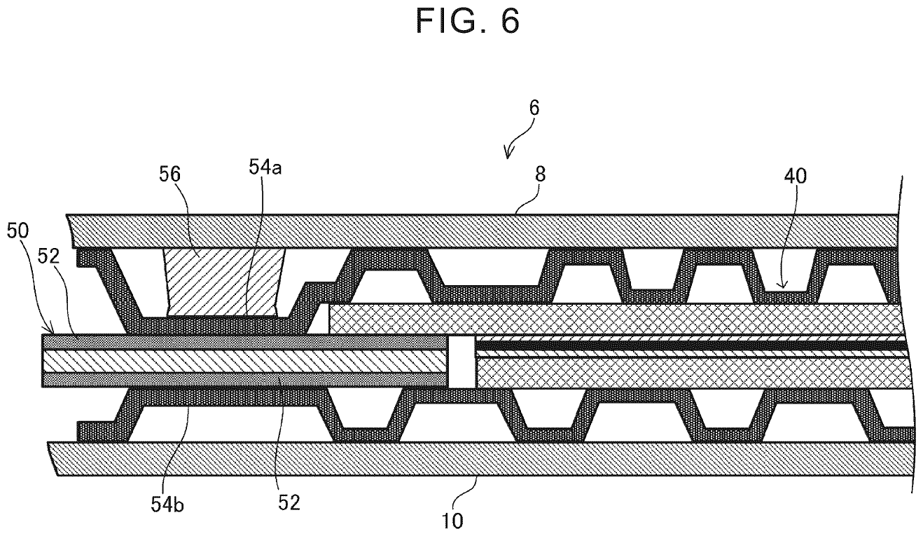

In the above embodiment, the laminated body 40 is supplied to the manufacturing device 2 in a state of being sandwiched by the jig 60, but the present disclosure is not limited thereto. For example, as shown in FIG. 6, an elastic member such as the gasket 56 may be placed on the separator 54a, and the gasket 56 may be compressed and deformed by the pair of belts 6, so that the pressure from the manufacturing device 2 is applied to the adhesive layers 52. The clastic body is not limited to the gasket 56, and may be an elastic body separately arranged for pressurization.

In the above-described embodiment, the restraining member 64 uses a magnetic force, but the present disclosure is not limited thereto. For example, the upper plate 60a and the lower plate 60b of the jig 60 can be restrained by using a fastening member such as a screw or an elastic member such as a spring with respect to the jig 60 so that the load after the heating press step S20 is not completely released. The restraining member 64 allows the load on the adhesive layers 52 to be maintained between the heating press step S20 and the cooling press step S30.

In the above embodiments, the embodiments using the double belt press apparatus and the continuous roller press apparatus have been described, but the manufacturing method disclosed in this specification is not implemented in the embodiments using these apparatuses. For example, a press die that presses the laminated body 40 including the adhesive layer 52 of the laminated body 40 may be used to heat such a press die and then cool the press die without demolding the laminate from the press die. In this manner, it is possible to maintain a predetermined load in the adhesive layers 52 in the heating press step S20 and to supply the same to the cooling press step S30. The step from the heating press step S20 to the cooling press step S30 can be performed without using a special conveying unit.

Alternatively, in the manufacturing methods disclosed herein, the heating press step S20 may be performed, and thereafter, for example, the cooling press step S30 may be performed by partially loosening the pressing process by the press mold, and then clamping the mold to perform the cold pressing process at a predetermined pressure.

In the above-described embodiment, the manufacturing devices 2 and 102 perform the heating press step S20 and the single cooling press step S30, but the present disclosure is not limited thereto. The heating press step S20 and the cooling press step S30 may each comprise one or more steps.

The present specification includes the following aspects.
[1] A fuel cell manufacturing device, comprising:
A conveying unit for conveying the laminated body in which the constituent elements of the fuel cell are laminated and arranged through an adhesive layer containing a thermoplastic resin material,
A heating unit for heating the laminate when the laminate conveyed by the conveying unit is located in a predetermined heating zone,
cooling unit for cooling the laminate when the laminate conveyed by the conveying unit is located in a predetermined cooling zone after passing through the heating zone,
pressurizing unit for continuing to pressurize the laminate after it is heated in the heating zone until it is cooled in the cooling zone,
A manufacturing device comprising:
[2] The manufacturing device includes a double belt press device,
The double belt press device,
A pair of upper and lower belts constituting the conveying unit,
A heating press part constituting a part of the heating unit and the pressurizing unit,
A cooling press part constituting another part of the cooling unit and the pressurizing unit,
The manufacturing device according to [1].
[3] The manufacturing device includes a continuous roller press device,
The continuous roller pressing device includes a pair of upper and lower roller conveyors constituting the conveying unit,
The manufacturing device according to [1] or [2], wherein the pair of upper and lower roller conveyors includes a heating press part constituting a part of the heating unit and the pressurizing unit, and a cooling press part constituting another part of the cooling unit and the pressurizing unit.
[4] The pressurizing unit includes a jig capable of pressing the adhesive layer while sandwiching the laminate in the laminating direction of the laminate,
The manufacturing device according to any one of [1] to [3], wherein the jig includes a pair of plates that sandwich the laminate, and includes a positioning member that suppresses a positional deviation of the pair of plates in a direction orthogonal to a stacking direction of the laminate.
[5] The manufacturing device according to [4], wherein the jig includes a pressing portion that presses the adhesive layer of the laminate.
[6] The manufacturing device according to [5], wherein the pressing portion includes an elastic body.
[7] The manufacturing device according to any one of [4] to [6], wherein the jig includes a restraining member capable of holding a load to the adhesive layer.
[8] A fuel cell manufacturing method, comprising:
a hot pressing step of heating and pressurizing the laminate comprising an adhesive layer containing a thermoplastic resin material,
a cooling press step for cooling and pressurizing the laminate after the heating press step, wherein
a manufacturing method, wherein the laminated body after the hot pressing step is supplied to the cooling pressing step in a state where at least a predetermined load in the adhesive layer is maintained.

While specific examples of the technology disclosed in the present specification have been described in detail above, these examples are merely illustrative and do not limit the scope of the claims. The technology described in the claims includes various modifications and variations of the specific examples described above, for example, a method of controlling a fuel cell. The technical elements described in this specification or in the drawings may be used alone or in various combinations, and are not limited to the 10 combinations described in the claims at the time of filing. The technology illustrated in the present specification or the drawings can achieve a plurality of objects at the same time, and has technical usefulness in achieving one of the objects.

What is claimed is:

1. A fuel cell manufacturing device comprising:
a conveying unit that conveys a stacked body in which constituent elements of a fuel cell are stacked via an adhesive layer containing a thermoplastic resin material;
a heating unit that heats the stacked body when the stacked body conveyed by the conveying unit is positioned in a predetermined heating zone;
a cooling unit that cools the stacked body when the stacked body conveyed by the conveying unit is positioned in a predetermined cooling zone after passing through the heating zone; and
a pressurizing unit that keeps pressurizing the stacked body since the stacked body is heated in the heating zone until the stacked body is cooled in the cooling zone.

2. The manufacturing device according to claim 1, wherein:
the manufacturing device includes a double belt press device; and
the double belt press device includes
a pair of upper and lower belts that constitutes the conveying unit,
a heating press portion that constitutes the heating unit and a part of the pressurizing unit, and
a cooling press portion that constitutes the cooling unit and another part of the pressurizing unit.

3. The manufacturing device according to claim 1, wherein:
the manufacturing device includes a continuous roller press device;
the continuous roller press device includes a pair of upper and lower roller conveyors that constitutes the conveying unit; and
the upper and lower roller conveyors include a heating press portion that constitutes the heating unit and a part of the pressurizing unit, and a cooling press portion that constitutes the cooling unit and another part of the pressurizing unit.

4. The manufacturing device according to claim 1, wherein:
the pressurizing unit includes a jig capable of pressurizing the adhesive layer while sandwiching the stacked body in a stacking direction of the stacked body; and
the jig includes a pair of plates that sandwiches the stacked body, and a positioning member that suppresses positional deviation of the plates in a direction orthogonal to the stacking direction of the stacked body.

5. A fuel cell manufacturing method comprising:
heating and pressurizing a stacked body including an adhesive layer containing a thermoplastic resin material; and
cooling and pressurizing the stacked body after the heating and pressurizing, wherein the stacked body after the heating and pressurizing is supplied to the cooling and pressurizing in a state in which at least a predetermined load on the adhesive layer is maintained.
